(19) United States
(12) Patent Application Publication
(10) Pub. No.: US 2026/0213832 A1
(43) Pub. Date: Jul. 23, 2026

(54) METHODS, COMMUNICATION DEVICE AND SATELLITE TRANSMITTER FOR CELL SYNCHRONIZATION IN NON-GEOSTATIONARY ORBIT SATELLITE MOBILE COMMUNICATION SYSTEM

(71) Applicant: HUAWEI TECHNOLOGIES CO., LTD., Shenzhen (CN)

(72) Inventors: Mohammad Bassem Abd Allah Momani, Munich (DE); Rainer Bachl, Munich (DE); Ahmed Abdelkader, Munich (DE); Zhibin Yu, Munich (DE)

(21) Appl. No.: 19/564,453

(22) Filed: Mar. 12, 2026

Related U.S. Application Data
(63) Continuation of application No. PCT/EP2023/075164, filed on Sep. 13, 2023.

(51) Int. Cl. H04B 7/185; H04B 7/195

(52) U.S. Cl. CPC H04B 7/18513; H04B 7/18534; H04B 7/18539; H04B 7/195

(57) ABSTRACT

In a Non-Geostationary Orbit, NGSO, satellite mobile communication system a communication device receives a partially pre-compensated synchronization signal block, SSB, through a downlink, DL, beam from a NGSO satellite transmitter and achieves a cell synchronization with the NGSO satellite transmitter using the partially pre-compensated SSB. Central frequencies of a primary synchronization signal and a secondary synchronization signal within the partially pre-compensated SSB are pre-shifted by the NGSO satellite transmitter with respect to a central frequency of the partially pre-compensated SSB by an integer number of subcarriers for a partial pre-compensation of a Doppler shift, DS, related to a movement of the NGSO satellite transmitter with respect to a coverage area of the DL beam on Earth. Cell synchronization is simplified even in the presence of high Doppler shifts due to high-mobility nature of NGSO satellites.

### CROSS-REFERENCE TO RELATED APPLICATIONS

This application is a continuation of International Application No. PCT/EP2023/075164, filed on Sep. 13, 2023, the disclosure of which is hereby incorporated by reference in its entirety.

### TECHNICAL FIELD

The present disclosure relates generally to the field of communication system; and more specifically, to methods of cell synchronization in a Non-Geostationary Orbit, NGSO, satellite mobile communication system, a communication device for cell synchronization in the NGSO satellite mobile communication system and a NGSO satellite transmitter.

### BACKGROUND

The Doppler shift, DS, is a well-known phenomenon characterized by a change in nominal carrier frequency of a signal as a result of relative motion between the signal source and an observer. In the realm of Non-Terrestrial Networks, NTNs, the Doppler shift significantly impacts the performance of satellite-based communication systems. The magnitude of the Doppler shift depends upon various factors, including the velocity of a satellite in an orbit, position and velocity of a User Equipment, UE, and a carrier frequency employed. The satellite velocity depends on the orbit height as defined by Kepler's laws of planetary motion. Typically, Low Earth Orbit, LEO, satellites maintain velocities of the order of approximately 28,000 kilometers per hour (km/h). In contrast, the velocity of UE is contingent upon both the rotational speed of Earth at a specific latitude of operation and movement of the UE itself. Notably, the highest rotational speed of Earth occurs at the equator and is approximately 1,670 km/h. In an exemplary scenario, the Doppler shift for a carrier frequency of 3.7 GHz is observed on Earth at a certain distance from a sub-satellite point, considering the heights of 400, 800, and 1200 kilometers for LEO satellites. It is also observed that the Doppler shift due to the satellite movement exceeds±70 kHz. Therefore, it may be stated that the Doppler shift is proportional to the carrier frequency, which means that in higher frequency bands the Doppler shift can be substantially larger than Subcarrier Spacing, SCS. In the context of NTNs communication, the SCS values can vary based on the frequency bands being utilized. For instance, in Sub-6 GHZ bands commonly used in 5G New Radio, 5G NR, the possible SCS values are [15, 30, 60] kHz, while higher frequency bands can entail the SCS values of [60, 120, 240] kHz. Currently, for NTNs-to-UE direct access, the SCS values are specified as [15, 30] kHz according to Third Generation Partnership Project, 3GPP, Technical Report, TR38.821. In Orthogonal Frequency-Division Multiplexing, OFDM-based systems like 5G NR, the Doppler shift, measured in hertz, Hz, introduces an offset between the carrier frequency of received signal and frequency grid of an OFDM system, known as a Carrier Frequency Offset, CFO. The CFO is required to be estimated and compensated at the receiver for correct demodulation. For LEO NTNs communications, the CFO induced by the Doppler shift can be a multiple of the SCS and surpassing the threshold values. For cell search, the UE is required to perform hypothesis testing on different hypothetical subcarrier shifts to detect synchronization signals, not only in time domain but also in frequency domain. This can be done by the UE to shift its locally generated synchronization signal replicas along the frequency axis in multiples of the SCS, which is computationally intensive especially when the timing boundary of the OFDM signals is not known.

Currently, certain attempts have been made in order to reduce the synchronization complexity at the UE due to high Doppler shift in NTNs, such as full Doppler shift-compensation, wherein a pre-compensated value corresponds to the Doppler shift value at the beam center. The pre-compensation can be applied either on all the Downlink, DL channels or on the whole Synchronization Signal Block, SSB. By pre-compensating the full Doppler shift at the satellite by shifting the Radio Frequency, RF in each beam to counteract the Doppler shift, the following technical issues can be distinguished. When a full Doppler shift value is pre-compensated at transmitter's side, the numerology of transmitted OFDM waveform is not according to the current NR standard. The reason being, the subcarriers of the transmitted signal are shifted by a non-integer amount of the SCS, which breaks the frequency grid structure of the OFDM system in the transmitter side. When the pre-compensation is applied on the whole SSB, the UE still requires to know the absolute Doppler shift value that was pre-compensated at the satellite, so as to correctly know the frequency allocation of other data channels, which increases the control overhead. When the pre-compensation is applied on all the DL channels, it introduces the extra power consumption and the computational complexity for a Base Station, BS transmitter. Thus, there exists a technical problem of computationally intensive cell search mechanism in the presence of high Doppler shifts due to high-mobility nature of LEO satellites.

Therefore, in light of the foregoing discussion, there exists a need to overcome the aforementioned drawbacks associated with the conventional methods of reducing the cell synchronization computational complexity due to high Doppler shifts in NTNs.

### SUMMARY

The present disclosure provides methods of cell synchronization in a Non-Geostationary Orbit, NGSO, satellite mobile communication system, a communication device for cell synchronization in the NGSO satellite mobile communication system and a NGSO satellite transmitter. The present disclosure provides a solution to the existing problem of computationally intensive cell search mechanism in the presence of high Doppler shifts due to high-mobility nature of LEO satellites. An aim of the present disclosure is to provide a solution that overcomes at least partially the problems encountered in prior art, and provide improved methods of cell synchronization in a Non-Geostationary Orbit, NGSO, satellite mobile communication system, a communication device for cell synchronization in the NGSO satellite mobile communication system and a NGSO satellite transmitter.

The object of the present disclosure is achieved by the solutions provided in the enclosed independent claims. Advantageous implementations of the present disclosure are further defined in the dependent claims.

In one aspect, the present disclosure provides a method of cell synchronization in a Non-Geostationary Orbit, NGSO, satellite mobile communication system. The method comprises a communication device receiving a partially pre-compensated synchronization signal block, SSB, through a downlink, DL, beam from a NGSO satellite transmitter and achieving a cell synchronization with the NGSO satellite transmitter using the partially pre-compensated SSB, where a central frequency of a primary synchronization signal, PSS, and a central frequency of a secondary synchronization signal, SSS, within the partially pre-compensated SSB are pre-shifted by the NGSO satellite transmitter with respect to a central frequency of the partially pre-compensated SSB by an integer number of subcarriers for a partial pre-compensation of a Doppler shift related to a movement of the NGSO satellite transmitter with respect to a coverage area of the DL beam on Earth.

The disclosed method enables a simplified cell synchronization mechanism even in the presence of high Doppler shifts due to high-mobility nature of LEO satellites. The disclosed method enables the partial Doppler shift pre-compensation by pre-shifting the PSS and the SSS subcarrier positions within the existing null-subcarrier region within a SSB. Consequently, New Radio, NR, numerology is not broken in transmitted signals as the PSS and the SSS subcarriers are still on the pre-defined frequency grids. Also, the spectrum efficiency is kept because the shifting is applied within the existing null-subcarrier region.

In an implementation form, the integer number of subcarriers to which the central frequencies of the PSS and the SSS are pre-shifted within the partially pre-compensated SSB is determined based on an orbital height and a velocity of the NGSO satellite transmitter, the coverage area of the DL beam, a carrier frequency of a DL channel and a subcarrier spacing, SCS, of the partially pre-compensated SSB.

This is advantageous to use aforementioned factors in determining the integer number of subcarriers to which the central frequencies of the PSS and the SSS within the partially pre-compensated SSB are pre-shifted in order to achieve an accurate and reliable partial pre-compensation of the Doppler shift.

In a further implementation form, the central frequencies of the PSS and the SSS are pre-shifted in a range from −9 to +9 subcarriers within a null-subcarrier region of the partially pre-compensated SSB.

The pre-shifting of the central frequencies of the PSS and SSS within the null-subcarrier region of the partially pre-compensated SSB maintains the NR numerology of transmitted signals as well as along with a reduced computational complexity for UE to apply cell synchronization.

In a further implementation form, the method further comprises for achieving the cell synchronization: the communication device correlating received DL signals containing the partially pre-compensated SSB with a set of locally generated PSS waveforms each being shifted in frequency by a potential value of a residual part of the Doppler shift non-compensated by the partial pre-compensation by the NGSO satellite transmitter and determining a maximum correlation value.

The determination of the maximum correlation value implies that the NGSO satellite transmitter is employing the partial Doppler shift pre-compensation on the PSS and SSS resulting in a reduced explicit signaling between the NGSO satellite transmitter and the communication device.

In a further implementation form, the method further comprises, if the maximum correlation value is below a pre-defined threshold: the communication device achieving the cell synchronization by correlating the DL signals with a larger set of locally generated PSS waveforms each being shifted in frequency by a potential value of a maximum possible Doppler shift related to the NGSO satellite transmitter movement with respect to the DL beam coverage area.

The determination of the maximum correlation value below pre-defined threshold value implies that the NGSO satellite transmitter is not employing the partial Doppler shift pre-compensation on the PSS and SSS resulting in a reduced explicit signaling between the NGSO satellite transmitter and the communication device.

In a further implementation form, the method further comprises, upon achieving the cell synchronization: the communication device detecting a physical cell identity, PCI, and estimating the residual part of the Doppler shift based on the received PSS and SSS.

The is advantageous to detect the PCI and estimate the residual part of the Doppler shift based on the received PSS and SSS with reduced computational complexity.

In a further implementation form, the method further comprises the communication device determining a value of the partial pre-compensation of the Doppler shift by the NGSO satellite transmitter based on a difference between the central frequencies of the subcarriers of the received PSS and SSS and a received demodulation reference signal, DMRS, for a physical broadcast channel, PBCH, within the partially pre-compensated SSB.

The method enables the determination of the absolute Doppler shift information by measuring the relative frequency spacing between the partial Doppler shift pre-compensated PSS and SSS and the un-pre-compensated PBCH DMRS within the same SSB. Consequently, there is no requirement to introduce extra control signaling to indicate the absolute Doppler shift value to the communication device.

In a further implementation form, the method further comprises the communication device determining a value of the Doppler shift related to the NGSO satellite transmitter movement with respect to the coverage area of the DL beam based on the estimated residual part of the Doppler shift and the determined value of the partial pre-compensation of the Doppler shift.

The determined value of Doppler shift related to the NGSO satellite transmitter movement with respect to the coverage area of the DL beam based on the estimated residual part of the Doppler shift and the determined value of the partial pre-compensation of the Doppler shift can be used to compensate other DL channels which are not partially compensated.

In a further implementation form, the method further comprises the communication device using the determined value of the Doppler shift to compensate a phase distortion of a DL data signal associated with the DL beam, where the DL data signal comprises a Physical Downlink Control Channel, PDCCH, signal or a Physical Downlink Shared Channel, PDSCH, signal.

The disclosed method enhances the spectrum efficiency of various communication channels including the PDCCH, PDSCH, Physical Uplink Shared Control Channel, PUSCH, and Physical Uplink Control Channel, PUCCH as well as reduces the processing complexity and control overhead of aforementioned channels.

In a further implementation form, the method further comprises the communication device determining that the partial pre-compensation of the Doppler shift is applied by the NGSO satellite transmitter to DL signals if the PCI detected based on the received PSS and SSS belongs to a pre-defined set of identities.

This is advantageous to indicate the communication device that whether the NGSO satellite transmitter applies the partial pre-compensation of the Doppler shift on the PSS and SSS or not resulting in a reduced signalling overhead.

In a further implementation form, the method further comprises, by the communication device determining a SCS ratio between a Physical Random Access Channel, PRACH, signal, and the SCS used in the partially pre-compensated SSB, and pre-shifting the PRACH subcarrier positions in the PRACH signal by a value defined by the determined value of the partial pre-compensation of the Doppler shift and the determined SCS ratio, and transmitting the pre-shifted PRACH signal to the NGSO satellite transmitter.

The method includes the partial Doppler shift pre-compensation by pre-shifting the PRACH subcarrier positions based on the detected partial Doppler shift pre-compensation of the PSS and SSS, resulting no change in the NR numerology of transmitted signals. Additionally, the method enables a simplified detection of PRACH signals for a base station.

In another aspect, the present disclosure provides a communication device for cell synchronization in a Non-Geostationary Orbit, NGSO, satellite mobile communication system. The communication device is configured for receiving a partially pre-compensated synchronization signal block, SSB, through a downlink, DL, beam from a NGSO satellite transmitter, and achieving a cell synchronization with the NGSO satellite transmitter using the partially pre-compensated SSB, where a central frequency of a primary synchronization signal, PSS, and a central frequency of a secondary synchronization signal, SSS, within the partially pre-compensated SSB are pre-shifted by the NGSO satellite transmitter with respect to a central frequency of the partially pre-compensated SSB by an integer number of subcarriers for a partial pre-compensation of a Doppler shift related to a movement of the NGSO satellite transmitter with respect to a coverage area of the DL beam on Earth.

The communication device achieves all the advantages and technical effects of the method after execution of the method.

In a yet another aspect, the present disclosure provides a Non-Geostationary Orbit, NGSO, satellite transmitter configured for determining a value of a partial pre-compensation of a Doppler shift related to a movement of the NGSO satellite transmitter with respect to a coverage area of a downlink, DL, beam on Earth. The NGSO satellite transmitter is further configured for pre-shifting a central frequency of a primary synchronization signal, PSS, and a central frequency of a secondary synchronization signal, SSS, within a synchronization signal block, SSB, with respect to a central frequency of the SSB by an integer number of subcarriers that corresponds to the determined value of the partial pre-compensation of the Doppler shift to obtain a partially pre-compensated SSB. The NGSO satellite transmitter is further configured for transmitting the partially pre-compensated SSB within the coverage area of the DL beam.

The NGSO satellite transmitter achieves all the advantages and technical effects of the method after execution of the method.

In a yet another aspect, the present disclosure provides a method of cell synchronization in a Non-Geostationary Orbit, NGSO, satellite mobile communication system. The method comprises a NGSO satellite transmitter determining a value of a partial pre-compensation of a Doppler shift related to a movement of the NGSO satellite transmitter with respect to a coverage area of a downlink, DL, beam on Earth, the NGSO satellite transmitter pre-shifting a central frequency of a primary synchronization signal, PSS, and a central frequency of a secondary synchronization signal, SSS, within a synchronization signal block, SSB, with respect to a central frequency of the SSB by an integer number of subcarriers that corresponds to the determined value of the partial pre-compensation of the Doppler shift to obtain a partially pre-compensated SSB, and transmitting the partially pre-compensated SSB within the coverage area of the DL beam by the NGSO satellite transmitter.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of a method of cell synchronization in a Non-Geostationary Orbit, NGSO, satellite mobile communication system, in accordance with an embodiment of the present disclosure;

FIG. 2 illustrates a communication device for cell synchronization in a NGSO satellite mobile communication system, in accordance with an embodiment of the present disclosure;

FIG. 3 illustrates a NGSO satellite transmitter, in accordance with an embodiment of the present disclosure;

FIG. 4 is a flowchart of a method of cell synchronization in a NGSO satellite mobile communication system, in accordance with another embodiment of the present disclosure;

FIG. 5 illustrates a Synchronization Signal Block, SSB, with frequency sub-carrier shifted Primary Synchronization Signal, PSS, and Secondary Synchronization Signal, SSS, in accordance with an embodiment of the present disclosure;

FIG. 6 is a method used by a User Equipment, UE, to detect the absolute Doppler shift using a partial Doppler shift pre-compensated SSB, in accordance with an embodiment of the present disclosure;

FIG. 7 is a flowchart used by a UE to determine whether a Base Station, BS, is applying a partial Doppler shift pre-compensation without explicit signaling, in accordance with an embodiment of the present disclosure;

FIG. 8 is a method used by a UE to apply a partial Doppler shift pre-compensation on a Physical Random-Access Channel, PRACH, for the uplink, UL, transmission, in accordance with an embodiment of the present disclosure; and

FIG. 9 illustrates an exemplary scenario of partial Doppler shift pre-compensation of PRACH, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

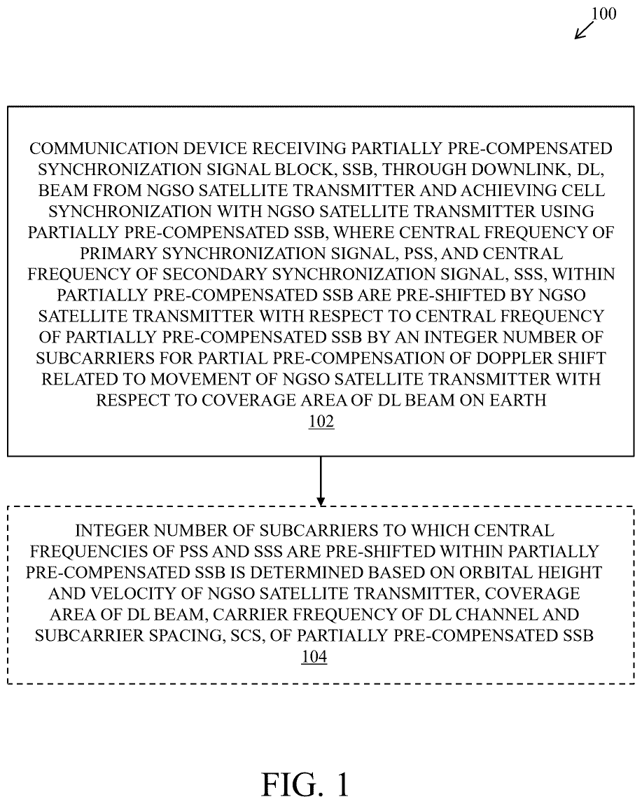

FIG. 1 is a flowchart of a method of cell synchronization in a Non-Geostationary Orbit, NGSO, satellite mobile communication system, in accordance with an embodiment of the present disclosure. With reference to FIG. 1, there is shown a method 100 of cell synchronization in a Non-Geostationary Orbit, NGSO, satellite mobile communication system. The method 100 includes steps 102 and 104. The step 104 is optional.

There is provided the method 100 of cell synchronization in a Non-Geostationary Orbit, NGSO, satellite mobile communication system. Traditionally, a satellite (e.g., a Low Earth Orbit, LEO satellite) to a User Equipment, UE, direct access requires the UE to achieve time and frequency synchronization through a process, known as a cell search. The cell search may be defined as an initial synchronization procedure, which is initiated by the UE when trying to first connect to a network (e.g., Non-Terrestrial Networks, NTNs) or reconnect after link interruption. The cell search involves identifying candidate cells detecting the synchronization signals to achieve time and frequency synchronization and determining the Physical Cell Identity, PCI, which is required to decode the Physical Broadcast Channel, PBCH. In the presence of high Doppler Shifts, DS due to high-mobility nature of LEO satellites, the cell search procedure becomes computationally expensive. In contrast to the conventional cell search procedure, the method 100 enables a simplified and an efficient cell search in the NTNs by minimizing two-dimensional, 2D, search for Primary Synchronization Signals, PSS, in time and frequency domain into one-dimensional, 1D search in time domain only, resulting in power saving at the UE. By reducing the search dimensionality, the method 100 enables less storage required for storing correlation results, which yields memory saving at the UE. Furthermore, the method 100 accelerates the cell search because the search space in terms of synchronization signal is significantly reduced which, means the UE is able to connect to the network in a faster way.

At step 102, the method 100 comprises a communication device receiving a partially pre-compensated synchronization signal block, SSB, through a downlink, DL, beam from a NGSO satellite transmitter and achieving a cell synchronization with the NGSO satellite transmitter using the partially pre-compensated SSB, where a central frequency of a primary synchronization signal, PSS, and a central frequency of a secondary synchronization signal, SSS, within the partially pre-compensated SSB are pre-shifted by the NGSO satellite transmitter with respect to a central frequency of the partially pre-compensated SSB by an integer number of subcarriers for a partial pre-compensation of a Doppler shift related to a movement of the NGSO satellite transmitter with respect to a coverage area of the DL beam on Earth. For NTNs, the Doppler shifts vary among different satellite downlink beams therefore, a partial pre-compensation is proposed for the PSS and the SSS for each satellite beam in order to speed up the cell search (also known as cell detection). The meaning of the word “partial” is two-fold, first is only the PSS and the SSS within the SSB are pre-compensated and not the whole SSB. And second is only the integer part of the Doppler shift introduced by the satellite movement (or the movement of the NGSO satellite transmitter) is pre-compensated, not a full Doppler shift. The partial pre-compensation of the Doppler shift is achieved by shifting the PSS and the SSS subcarriers within the existing null-subcarrier region within the SSB. Consequently, the New Radio, NR numerology is not affected in the transmitted signals as the PSS and the SSS subcarriers are still on the pre-defined frequency grids. Also, the spectrum efficiency is maintained because the shifting is applied within the existing null-subcarrier region. In the method 100, after finishing the time/frequency synchronization using the pre-compensated PSS and SSS, the communication device (or the UE) can effortlessly detect the absolute value of the Doppler shift. This is done by detecting the frequency spacing between the pre-compensated PSS and SSS and un-pre-compensated PBCH Demodulation Reference Signal, DMRS, within the same SSB. As a result, there is no requirement to introduce extra control signaling to indicate the absolute Doppler shift value to the communication device (i.e., the UE). Additionally, the partially pre-compensated SSB is not generated by the communication device but received from the NGSO satellite transmitter, therefore, the partially pre-compensated SSB may also be referred to as a received partially pre-compensated SSB.

At step 104, the integer number of subcarriers to which the central frequencies of the PSS and the SSS are pre-shifted within the partially pre-compensated SSB is determined based on an orbital height and a velocity of the NGSO satellite transmitter, the coverage area of the DL beam, a carrier frequency of a DL channel and a subcarrier spacing, SCS, of the partially pre-compensated SSB. Alternatively stated, the absolute value of the Doppler shift of the DL beam in the satellite's (i.e., NGSO satellite transmitter's) coverage area is based on various network component's including the orbital height, the velocity of the NGSO satellite transmitter, the DL frequency band and the carrier frequency and beam location within the satellite's coverage area.

For a satellite (i.e., the NGSO satellite transmitter) beam projected on Earth's surface, the satellite determines the Doppler shift experienced by the communication device (i.e., the UE) in this beam due to the motion of the satellite. The satellite can infer the beam's Doppler shift information using the location of the beam with respect to the subsatellite point, the satellite's velocity, and the carrier frequency. The Doppler shift in terms of SCS comprises two parts, an integer part, and a fractional part (which is determined by the communication device or the UE). The absolute Doppler shift at the satellite is calculated according to equation (1)

$$DS = \frac{fc}{c} \sqrt{\frac{GM}{{R}_{E} + h}} cos ( α ) , \qquad ( 1 )$$

where, fc is the DL carrier frequency, c is the speed of light, G is the gravitational constant, M is Earth's mass, R_{E} is Earth's radius, h is the orbital height, and α is the angle between the direction of wave propagation for a specific beam and the direction of satellite movement. Generally, the subsatellite point refers to the point on Earth directly under the satellite, also known as a nadir point.

In accordance with an embodiment, the central frequencies of the PSS and the SSS are pre-shifted in a range from −9 to +9 subcarriers within a null-subcarrier region of the partially pre-compensated SSB. The central frequencies of the PSS and the SSS are pre-shifted within the null-subcarrier region based on the absolute value of the Doppler shift. Generally, a NR SSB comprises a PSS, a SSS and a PBCH. The SSB spans 240 subcarriers in the frequency domain and extends over 4 Orthogonal Frequency Division Multiplexing, OFDM symbols in time. The first and third OFDM symbols within the SSB comprises unused subcarriers, which are defined as “set to zero”. In the third OFDM symbol, where the SSS lies, there are 9 unused subcarriers above and 9 unused subcarriers below, making a total of 18 unused subcarriers. Therefore, for Fifth Generation, 5G, Frequency Range-1, FR1 (including Sub-6 GHZ frequency band), the maximum value of the Doppler shift that can be pre-compensated by the satellite (i.e., the NGSO satellite transmitter) is ±135 kHz and ±270 kHz for 15 kHz and 30 kHz Sub-Carrier Spacing, SCS, respectively. If the maximum pre-compensation value is reached on the satellite's side, the rest is handled at the communication device (i.e., at the UE).

For example, if the absolute value of the Doppler shift for a specific beam is found to be +75 kHz, then the amount of the PSS and SSS subcarrier shift is determined by the NGSO satellite transmitter as:

Case 1: 15 kHz SCS: sub-carrier

$$shift = - ⌊ \frac{+ 75 kHz}{15 kHz} ⌋ = - 5 \to$$

sub-carrier positions required to be shifted by 5 subcarriers.

Case 2: 30 kHz SCS: sub-carrier

$$shift = - ⌊ \frac{+ 75 kHz}{30 kHz} ⌋ = - ⌊ 2.5 ⌋ = 2 \to$$

sub-carrier positions required to be shifted by 2 subcarriers. The fractional amount is a residual Doppler shift that is estimated by the communication device (i.e., the UE).

In accordance with an embodiment, the method 100 further comprises, for achieving the cell synchronization: the communication device correlating received DL signals containing the partially pre-compensated SSB with a set of locally generated PSS waveforms each being shifted in frequency by a potential value of a residual part of the Doppler shift non-compensated by the partial pre-compensation by the NGSO satellite transmitter and determining a maximum correlation value. The PSS and SSS in the partially pre-compensated SSB are compensated for the integer part of the Doppler shift by the NGSO satellite transmitter. This further enables the communication device (i.e., the UE) to determine the start and end of the SSB in time domain simply by correlating the received SSB with the locally generated PSS and SSS in a computationally efficient manner by constructing locally-generated and time-shifted versions of the PSS and SSS templates, since no hypothesis the required in the frequency domain. The communication device (i.e., the UE) further determines the maximum correlation value by correlating the received DL signals with the set of locally generated PSS waveforms. If the communication device detects the maximum correlation value above a certain threshold value, the communication device computes the total Doppler shift according to the method 100.

In accordance with an embodiment, the method 100 further comprises, if the maximum correlation value is below a pre-defined threshold: the communication device achieving the cell synchronization by correlating the DL signals with a larger set of locally generated PSS waveforms each being shifted in frequency by a potential value of a maximum possible Doppler shift related to the NGSO satellite transmitter movement with respect to the DL beam coverage area. In a case, if the maximum correlation value is below the pre-defined threshold the communication device is required to correlate the DL signals with the larger set (i.e., a second set) of locally generated PSS waveforms shifted in both time and frequency in order to determine the total Doppler shift.

In accordance with an embodiment, the method 100 further comprises, upon achieving the cell synchronization: the communication device detecting a physical cell identity, PCI, and estimating the residual part of the Doppler shift based on the received PSS and SSS. After achieving the cell synchronization, the communication device (i.e., the UE) can detect the timing boundary of the PSS and the residual part of the Doppler shift using the same correlation technique without much complexity. Moreover, the communication device (i.e., the UE) can detect the PCI by correlating the received PSS and SSS with the 3 PSS and 336 SSS, locally generated sequences, respectively. The PCI is then calculated at the communication device according to equation (2)

$${N}_{id}^{cell} = 3 {N}_{id}^{( 1 )} + {N}_{id}^{( 2 )} \qquad ( 2 )$$

where

$${N}_{id}^{( 1 )} ∈ \{ 0 , 1 , ... , 335 \}$$

### is the SSS ID and

$${N}_{id}^{( 2 )} ∈ \{ 0 , 1 , 2 \}$$

### is the PSS ID.

In accordance with an embodiment, the method 100 further comprises the communication device determining a value of the partial pre-compensation of the Doppler shift by the NGSO satellite transmitter based on a difference between the central frequencies of the subcarriers of the received PSS and SSS and a received demodulation reference signal, DMRS, for a physical broadcast channel, PBCH, within the partially pre-compensated SSB. The communication device determines a set of all possible PBCH DMRS sub-carrier positions within the received partially pre-compensated SSB based on the detected PCI, and the maximum allowed pre-compensation value (e.g., ±9). The PBCH and all other physical channels are not frequency shifted. The DMRS from PBCH can be used to detect the frequency pre-compensation applied by the NGSO satellite transmitter for the PSS and the SSS. The DMRS from PBCH can be used with hypothesis test to detect the actual PSS and SSS frequency shift by N·SCS with −Nₘₐₓ≤N≤Nₘₐₓ whereby Nₘₐₓ≤9 is a network specific parameter that can be known to the communication device (i.e., the UE) in advance.

In accordance with an embodiment, the method 100 further comprises the communication device determining a value of the Doppler shift related to the NGSO satellite transmitter movement with respect to the coverage area of the DL beam based on the estimated residual part of the Doppler shift and the determined value of the partial pre-compensation of the Doppler shift. The communication device (i.e., the UE) determines the value of the Doppler shift (i.e., the total Doppler shift) based on the detected PSS and SSS sub-carrier shift and the estimated residual part of the Doppler shift. The PBCH DMRS subcarriers shift is also used in determination of the value of the Doppler shift.

In accordance with an embodiment, the method 100 further comprises the communication device using the determined value of the Doppler shift to compensate a phase distortion of a DL data signal associated with the DL beam, wherein the DL data signal comprises a Physical Downlink Control Channel, PDCCH, signal or a Physical Downlink Shared Channel, PDSCH, signal. In addition to compensation of the phase distortion of the DL data signal including the PDCCH signal or the PDSCH signal, the spectrum efficiency of aforementioned DL data signals is also enhanced using the determined value of the Doppler shift. In an implementation scenario, the determined value of the Doppler shift may also be used to enhance the spectrum efficiency of other communication channels, such as Physical Uplink Shared Channel, PUSCH or Physical Uplink Control Channel, PUCCH.

In accordance with an embodiment, the method 100 further comprises the communication device determining that the partial pre-compensation of the Doppler shift is applied by the NGSO satellite transmitter to DL signals if the PCI detected based on the received PSS and SSS belongs to a pre-defined set of identities. The communication device determines that whether the NGSO satellite transmitter applies the partial pre-compensation of the Doppler shift to DL signals or not depending on the detected PCI. The partial pre-compensation of the Doppler shift is applied for PCIs that belong to certain set of IDs (e.g., a first set), otherwise PCIs belong to another set of IDs (e.g., a second set) that do not apply partial Doppler shift pre-compensation. For example, even PCIs correspond to applying partial Doppler shift pre-compensation and odd PCIs correspond to not applying the partial Doppler shift pre-compensation.

In accordance with an embodiment, the method 100 further comprises, by the communication device determining a SCS ratio between a Physical Random-Access Channel, PRACH, signal, and the SCS used in the partially pre-compensated SSB, pre-shifting the PRACH subcarrier positions in the PRACH signal by a value defined by the determined value of the partial pre-compensation of the Doppler shift and the determined SCS ratio, and transmitting the pre-shifted PRACH signal to the NGSO satellite transmitter. In an implementation scenario, the PSS and SSS partial sub-carrier shift applied by the NGSO satellite transmitter is detected, which is used by the communication device in determining the SCS ratio between the PRACH signal and the SCS used in the partially pre-compensated SSB. Thereafter, the communication device pre-shifts the PRACH sub-carrier positions using the detected PSS and SSS Doppler shift pre-compensated partial sub-carrier shift and the SCS ratio between the partially pre-compensated SSB and the PRACH signal. Since, the detected PSS and SSS Doppler shift pre-compensated partial sub-carrier is known to the NGSO satellite transmitter, the PRACH sub-carrier shift is also known at the NGSO satellite transmitter.

Thus, the method 100 enables the partial Doppler shift pre-compensation by pre-shifting the PSS and the SSS sub-carrier positions within the existing null-subcarrier region within the SSB. Consequently, the NR numerology is maintained in the transmitted signals as the PSS and the SSS subcarriers are still on the pre-defined frequency grids. Also, the spectrum efficiency is maintained because the shifting is applied within the existing null-subcarrier region. Moreover, the method 100 enables a simplified cell synchronization mechanism even in the presence of high Doppler shifts due to high-mobility nature of LEO satellites. Furthermore, the method 100 enables the determination of the absolute Doppler shift information by measuring the relative frequency spacing between the partial Doppler shift pre-compensated PSS and SSS and the un-pre-compensated PBCH DMRS within the same SSB. Consequently, there is no requirement to introduce extra control signaling to indicate the absolute Doppler shift value to the communication device (i.e., the UE). Moreover, the method 100 includes the partial Doppler shift pre-compensation by shifting the PRACH sub-carrier positions based on the detected partial Doppler shift pre-compensation of the PSS and SSS, resulting no change in the NR numerology of transmitted signals.

The steps 102 and 104 is only illustrative and other alternatives can also be provided where one or more steps are added, one or more steps are removed, or one or more steps are provided in a different sequence without departing from the scope of the claims herein.

In one aspect, there is provided a computer program product comprising program instructions for performing the method 100, when executed by one or more processors in a system. In another aspect, the present disclosure provides a non-transitory computer-readable medium having stored thereon, computer-implemented instructions that, when executed by a computer, causes the computer to execute operations of the method 100.

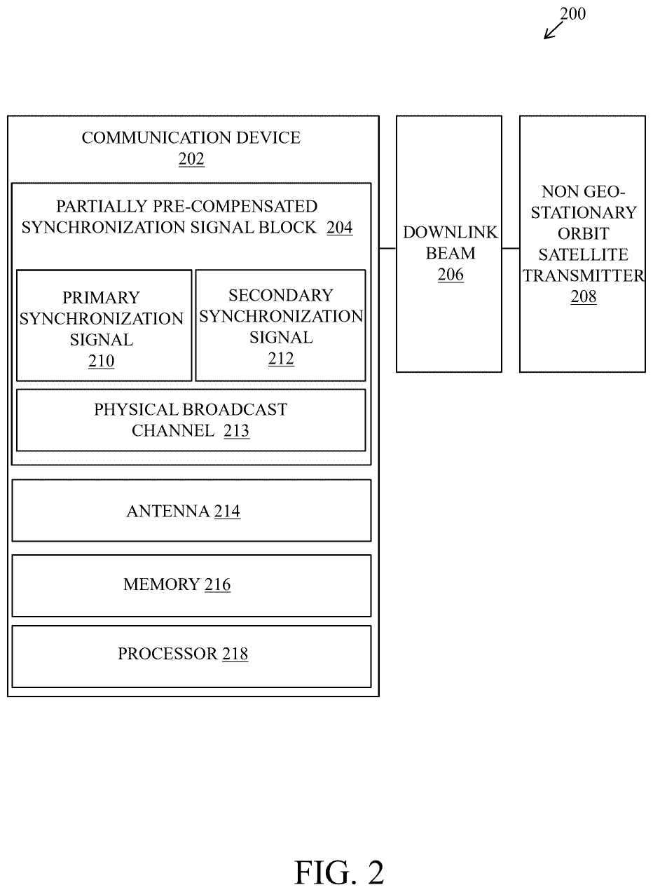

FIG. 2 illustrates a communication device for cell synchronization in a Non-Geostationary Orbit, NGSO, satellite mobile communication system, in accordance with an embodiment of the present disclosure. FIG. 2 is described in conjunction with elements from FIG. 1. With reference to FIG. 2, there is shown a communication device 202 for cell synchronization in a Non-Geostationary Orbit, NGSO, satellite mobile communication system 200. The communication device 202 is configured for receiving a partially pre-compensated synchronization signal block, SSB, 204 through a downlink, DL, beam 206 from a NGSO satellite transmitter 208. The partially pre-compensated SSB 204 comprises a primary synchronization signal, PSS 210, a secondary synchronization signal, SSS 212, and a physical broadcast channel, PBCH 213. Furthermore, the communication device 202 comprises an antenna 214, a memory 216 and a processor 218. The communication device 202 is configured to execute the method 100 (of FIG. 1).

The communication device 202 is configured for receiving the partially pre-compensated SSB 204 through the DL beam 206 from the NGSO satellite transmitter 208. Examples of the communication device 202 may include, but are not limited to, a smartphone product with NTN direct access capability, a smartphone product for high mobility scenarios, a receiving device, a customized hardware for wireless telecommunication, or any other portable or non-portable electronic device, and the like.

The antenna 214 may include suitable logic, circuitry, interfaces and/or code that is configured to receive the partially pre-compensated SSB 204 through the DL beam 206 from the NGSO satellite transmitter 208. Examples of the antenna 214 may include, but are not limited to, a radio frequency transceiver, a network interface, a telematics unit, or any antenna suitable for use in a user equipment, a repeater, a base station or other portable or non-portable communication devices.

The memory 216 may include suitable logic, circuitry, interfaces and/or code that is configured to store machine code and/or instructions executable by the processor 218. Examples of implementation of the memory 216 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. The memory 216 may store an operating system and/or a computer program product to operate the communication device 202. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

The processor 218 may include suitable logic, circuitry, interfaces and/or code that is configured to execute instructions stored in the memory 216. Examples of the processor 218 may include, but are not limited to an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 218 may refer to one or more individual processors, processing devices, a processing unit that is part of a machine.

In operation, the communication device 202 is configured for receiving the partially pre-compensated SSB 204 through the DL beam 206 from the NGSO satellite transmitter 208. The communication device 202 is further configured for achieving a cell synchronization with the NGSO satellite transmitter 208 using the partially pre-compensated SSB 204, where a central frequency of the PSS 210 and a central frequency of the SSS 212, within the partially pre-compensated SSB 204 are pre-shifted by the NGSO satellite transmitter 208 with respect to a central frequency of the partially pre-compensated SSB 204 by an integer number of subcarriers for a partial pre-compensation of a Doppler shift related to a movement of the NGSO satellite transmitter 208 with respect to a coverage area of the DL beam 206 on Earth. The communication device 202 is configured to partially pre-compensate the Doppler shift by shifting subcarriers of the PSS 210 and the SSS 212 within the existing null-sub-carrier region within the SSB, have been described in detail, for example, in FIG. 1. Consequently, the communication device 202 can easily detect the PSS 210 and the SSS 212 with reduced complexity. After detecting the PSS 210 and the SSS 212, the communication device 202 can compute the PCI in a simplified way. Also, the transmitted signal is complaint with the NR numerology.

In accordance with an embodiment, the integer number of subcarriers to which the central frequencies of the PSS 210 and the SSS 212 are pre-shifted within the partially pre-compensated SSB 204 is determined based on an orbital height and a velocity of the NGSO satellite transmitter 208, the coverage area of the DL beam 206, a carrier frequency of a DL channel and a subcarrier spacing, SCS, of the partially pre-compensated SSB 204. The absolute value of the Doppler shift of the DL beam 206 in the NGSO satellite transmitter 208 coverage area is based on the orbital height, the velocity of the NGSO satellite transmitter 208, the DL frequency band and the carrier frequency and beam location within the NGSO satellite transmitter 208 coverage area.

In accordance with an embodiment, the central frequencies of the PSS 210 and the SSS 212 are pre-shifted in a range from −9 to +9 subcarriers within a null-subcarrier region of the partially pre-compensated SSB 204. The SSS 212 has 9 unused subcarriers above and 9 unused subcarriers below, making a total of 18 unused subcarriers. Therefore, the central frequencies of the PSS 210 and the SSS 212 are pre-shifted in the range from −9 to +9 within the null-subcarrier region of the partially pre-compensated SSB 204, have been described in detail, for example, in FIG. 1.

In accordance with an embodiment, the communication device 202 is further configured for achieving the cell synchronization by means of correlating received DL signals containing the partially pre-compensated SSB 204 with a set of locally generated PSS waveforms each being shifted in frequency by a potential value of a residual part of the Doppler shift non-compensated by the partial pre-compensation by the NGSO satellite transmitter 208, and determining a maximum correlation value. In an implementation scenario, the communication device 202 assumes that the NGSO satellite transmitter 208 employs the partial pre-compensation of the Doppler shift. Thereafter, the communication device 202 proceeds to determine the SSB timing boundary by correlating received DL signals with the set of locally generated PSS waveforms (or local PSS templates). If the communication device 202 detects a PSS peak above a certain threshold value, the communication device 202 computes the total Doppler shift according to the method 100 (of FIG. 1).

In accordance with an embodiment, the communication device 202 is further configured, if the maximum correlation value is below a pre-defined threshold, for achieving the cell synchronization by correlating the DL signals with a larger set of locally generated PSS waveforms each being shifted in frequency by a potential value of a maximum possible Doppler shift related to the NGSO satellite transmitter 208 movement with respect to the DL beam 206 coverage area. In a case, if the maximum correlation value is below the pre-defined threshold the communication device 202 is required to correlate the DL signals with the larger set (i.e., a second set) of locally generated PSS waveforms shifted in both time and frequency in order to determine the total Doppler shift.

In accordance with an embodiment, the communication device 202 is further configured, upon achieving the cell synchronization, for detecting a physical cell identity, PCI, and estimating the residual part of the Doppler shift based on the received PSS and SSS. The communication device 202 is configured to detect the PCI and estimate the residual part of the Doppler shift based on the PSS 210 and the SSS 212, have been described in detail, for example, in FIG. 1.

In accordance with an embodiment, the communication device 202 is further configured for determining a value of the partial pre-compensation of the Doppler shift by the NGSO satellite transmitter 208 based on a difference between the central frequencies of the subcarriers of the received PSS and SSS and a received demodulation reference signal, DMRS, for the physical broadcast channel, PBCH 213, within the partially pre-compensated SSB 204. The communication device 202 is configured to determine a set of all possible PBCH DMRS sub-carrier positions within the partially pre-compensated SSB 204 based on the detected PCI, and the maximum allowed pre-compensation value (e.g., +9). The communication device 202 is further configured to extract the PBCH DMRS subcarriers for each possible position in the set from the partially pre-compensated SSB 204 and correlate the extracted PBCH DMRS subcarrier with a locally generated DMRS sequence.

In accordance with an embodiment, the communication device 202 is further configured for determining a value of the Doppler shift related to the NGSO satellite transmitter 208 movement with respect to the coverage area of the DL beam 206 based on the estimated residual part of the Doppler shift and the determined value of the partial pre-compensation of the Doppler shift. The communication device 202 is configured to determine the value of the Doppler shift (i.e., the total Doppler shift) based on the detected PSS and SSS subcarrier shift and the estimated residual part of the Doppler shift.

In accordance with an embodiment, the communication device 202 is further configured for using the determined value of the Doppler shift to compensate a phase distortion of a DL data signal associated with the DL beam 206, wherein the DL data signal comprises a Physical Downlink Control Channel, PDCCH, signal or a Physical Downlink Shared Channel, PDSCH, signal. In an implementation scenario, the communication device 202 is configured to use the determined value of the Doppler shift in order to enhance the spectrum efficiency of other communication channels, such as Physical Uplink Shared Channel, PUSCH or Physical Uplink Control Channel, PUCCH.

In accordance with an embodiment, the communication device 202 is further configured for determining that the partial pre-compensation of the Doppler shift is applied by the NGSO satellite transmitter 208 to DL signals if the PCI detected based on the received PSS and SSS belongs to a pre-defined set of identities. The communication device 202 is configured to determine that whether the NGSO satellite transmitter 208 applies the partial pre-compensation of the Doppler shift to DL signals or not depending on the detected PCI, have been described in detail, for example, in FIG. 1.

In accordance with an embodiment, the communication device 202 is further configured for determining a SCS ratio between a Physical Random Access Channel, PRACH, signal, and the SCS used in the partially pre-compensated SSB 204, pre-shifting the PRACH subcarrier positions in the PRACH signal by a value defined by the determined value of the partial pre-compensation of the Doppler shift and the determined SCS ratio, and transmitting the pre-shifted PRACH signal to the NGSO satellite transmitter 208. In an implementation scenario, the PSS and SSS partial sub-carrier shift applied by the NGSO satellite transmitter 208 is detected, which is used by the communication device 202 in determining the SCS ratio between the PRACH signal and the SCS used in the partially pre-compensated SSB 204, described in detail, for example, in FIG. 1.

Thus, the communication device 202 manifests the partial Doppler shift pre-compensation by shifting the PSS 210 and the SSS 212 sub-carrier positions within the existing null-subcarrier region within the SSB and maintains the NR numerology in the transmitted signals. The reason being the PSS 210 and the SSS 212 subcarriers are still on the pre-defined frequency grids.

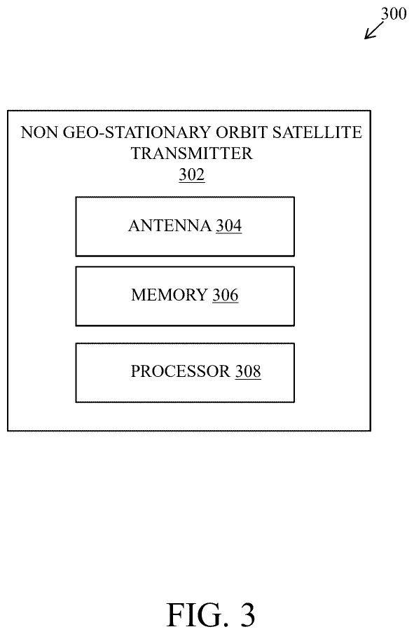

FIG. 3 illustrates a NGSO satellite transmitter, in accordance with an embodiment of the present disclosure. FIG. 3 is described in conjunction with elements from FIGS. 1 and 2. With reference to FIG. 3, there is shown a block diagram 300 of a NGSO satellite transmitter 302. The NGSO satellite transmitter 302 comprises an antenna 304, a memory 306 and a processor 308.

The NGSO satellite transmitter 302 corresponds to the NGSO satellite transmitter 208 (of FIG. 2). The NGSO satellite transmitter 302 is configured to execute the method 100 (of FIG. 1). Examples of the NGSO satellite transmitter 302 may include, but are not limited to, a base station (e.g., gNodeB, gNB) on board satellite, a base station (e.g., gNB) for high mobility scenarios, a transceiver, LEO satellite, and the like.

The antenna 304 may include suitable logic, circuitry, interfaces and/or code that is configured to transmit a partially pre-compensated SSB within coverage area of a DL beam. Examples of the antenna 304 may include, but are not limited to, a radio frequency transceiver, a network interface, a telematics unit, or any antenna suitable for use in a base station, a repeater, or other portable or non-portable communication devices.

The memory 306 may include suitable logic, circuitry, interfaces and/or code that is configured to store machine code and/or instructions executable by the processor 308. Examples of implementation of the memory 306 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. The memory 306 may store an operating system and/or a computer program product to operate the NGSO satellite transmitter 302. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

The processor 308 may include suitable logic, circuitry, interfaces and/or code that is configured to execute instructions stored in the memory 306. Examples of the processor 308 may include, but are not limited to an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 308 may refer to one or more individual processors, processing devices, a processing unit that is part of a machine.

In operation, the NGSO satellite transmitter 302 is configured for determining a value of a partial pre-compensation of a Doppler shift related to a movement of the NGSO satellite transmitter 302 with respect to a coverage area of a downlink, DL, beam on Earth. The NGSO satellite transmitter 302 determines the value of the partial pre-compensation of the Doppler shift for cell synchronization with a communication device (e.g., the communication device 202). The value of the partial pre-compensation of the Doppler shift is related to the movement of the NGSO satellite transmitter 302 with respect to the coverage area of the DL beam (e.g., the DL beam 206 of FIG. 2) on Earth.

The NGSO satellite transmitter 302 is further configured for pre-shifting a central frequency of a primary synchronization signal, PSS, and a central frequency of a secondary synchronization signal, SSS, within a synchronization signal block, SSB, with respect to a central frequency of the SSB by an integer number of subcarriers that corresponds to the determined value of the partial pre-compensation of the Doppler shift to obtain a partially pre-compensated SSB. The NGSO satellite transmitter 302 pre-shifts the central frequency of the PSS (e.g., the PSS 210 of FIG. 2) and the SSS (e.g., the SSS 212 of FIG. 2) towards the null-subcarrier region within the SSB to obtain the partially pre-compensated SSB (i.e., the partially pre-compensated SSB 204 of FIG. 2).

The NGSO satellite transmitter 302 is further configured for transmitting the partially pre-compensated SSB within the coverage area of the DL beam. The NGSO satellite transmitter 302 further transmits the partially pre-compensated SSB to a communication device (e.g., the communication device 202 of FIG. 2) on Earth.

In accordance with an embodiment, the integer number of subcarriers to which the central frequencies of the PSS and the SSS are pre-shifted within the partially pre-compensated SSB is determined based on an orbital height and a velocity of the NGSO satellite transmitter 302, the coverage area of the DL beam, a carrier frequency of a DL channel and a subcarrier spacing, SCS, of the partially pre-compensated SSB. The integer number of subcarriers to which the central frequencies of the PSS and the SSS are pre-shifted within the partially pre-compensated SSB depends on various factors, have been described in detail, for example, in FIG. 1.

In accordance with an embodiment, the central frequencies of the PSS and the SSS are pre-shifted in a range from −9 to +9 subcarriers within a null-subcarrier region of the partially pre-compensated SSB.

In accordance with an embodiment, the NGSO satellite transmitter 302 is further configured for selecting a physical cell identity, PCI, for a DL channel from a pre-defined set of identities to indicate that the partial pre-compensation of the Doppler shift is applied to DL signals. The selection of the PCI for the DL channel from the pre-defined set of identities has been described in detail, for example, in FIG. 1.

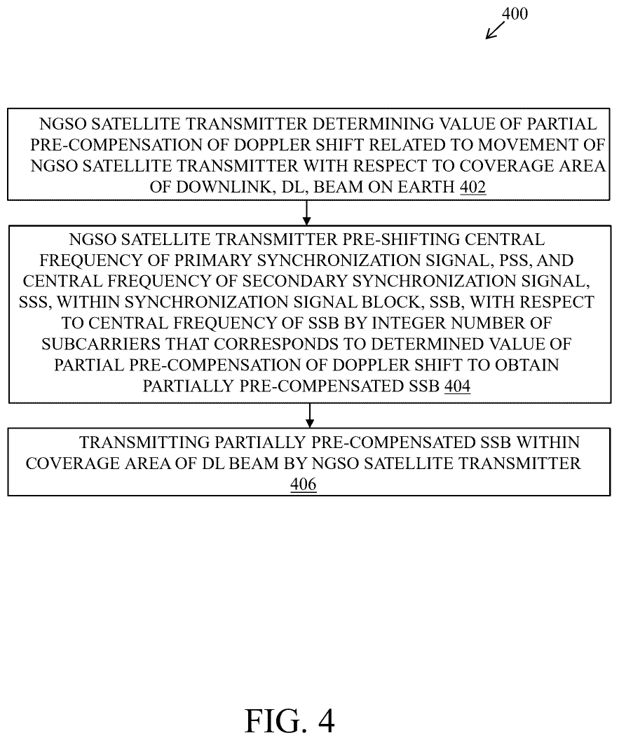

FIG. 4 is a flowchart of a method of cell synchronization in a NGSO satellite mobile communication system, in accordance with another embodiment of the present disclosure. FIG. 4 is described in conjunction with elements from FIGS. 1, 2, and 3. With reference to FIG. 4, there is shown a method 400 of cell synchronization in a NGSO satellite mobile communication system. The method 400 includes steps 402 to 406. The method 400 is executed by the NGSO satellite transmitter 302 (of FIG. 3).

At step 402, the method 400 comprises a NGSO satellite transmitter determining a value of a partial pre-compensation of a Doppler shift related to a movement of the NGSO satellite transmitter with respect to a coverage area of a DL beam on Earth. The determination of the value of the partial pre-compensation of the Doppler shift based on the movement of the NGSO satellite transmitter (e.g., the NGSO satellite transmitter 302 of FIG. 3) leads to a fast cell synchronization in LEO satellite mobile communication system (e.g., the NGSO satellite mobile communication system 200 of FIG. 2).

At step 404, the method 400 further comprises the NGSO satellite transmitter pre-shifting a central frequency of a primary synchronization signal, PSS, and a central frequency of a secondary synchronization signal, SSS, within a synchronization signal block, SSB, with respect to a central frequency of the SSB by an integer number of subcarriers that corresponds to the determined value of the partial pre-compensation of the Doppler shift to obtain a partially pre-compensated SSB. The pre-shifting of the central frequency of the PSS (e.g., the PSS 210 of FIG. 2) and the SSS (e.g., the SSS 212 of FIG. 2) towards a null-subcarrier region within the SSB to obtain the partially pre-compensated SSB (i.e., the partially pre-compensated SSB 204 of FIG. 2) is described in detail, for example, in FIGS. 1 and 2.

At step 406, the method 400 further comprises transmitting the partially pre-compensated SSB within the coverage area of the DL beam by the NGSO satellite transmitter. The partially pre-compensated SSB (i.e., the partially pre-compensated SSB 204 of FIG. 2) is transmitted to Earth within the coverage area of the DL beam (e.g., the DL beam 206 of FIG. 2) by use of the NGSO satellite transmitter (i.e., the NGSO satellite transmitter 302 of FIG. 3).

In accordance with an embodiment, the method 400 further comprises the NGSO satellite transmitter selecting a physical cell identity, PCI, for a DL channel from a pre-defined set of identities to indicate that the partial pre-compensation of the Doppler shift is applied to DL signals. The selection of the PCI for the DL channel from the pre-defined set of identities has been described in detail, for example, in FIG. 1.

The steps 402 to 406 are only illustrative and other alternatives can also be provided where one or more steps are added, one or more steps are removed, or one or more steps are provided in a different sequence without departing from the scope of the claims herein.

In one aspect, there is provided a computer program product comprising program instructions for performing the method 400, when executed by one or more processors (e.g., the processor 308 of the NGSO satellite transmitter 302, of FIG. 3) in a system. In another aspect, the present disclosure provides a non-transitory computer-readable medium having stored thereon, computer-implemented instructions that, when executed by a computer, causes the computer to execute operations of the method 400.

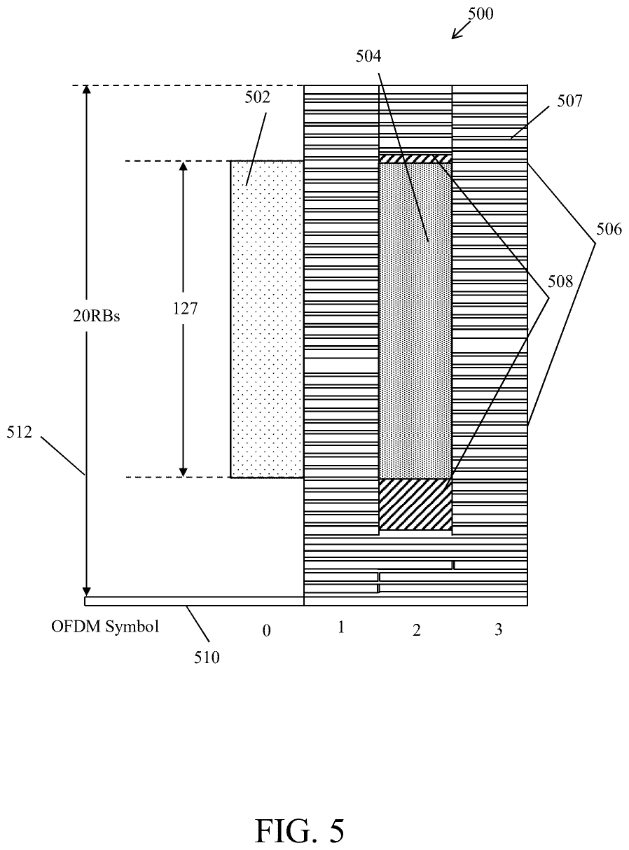

FIG. 5 illustrates a Synchronization Signal Block, SSB, with frequency sub-carrier shifted Primary Synchronization Signal, PSS, and Secondary Synchronization Signal, SSS, in accordance with an embodiment of the present disclosure. FIG. 5 is described in conjunction with elements from FIGS. 1, 2, 3, and 4. With reference to FIG. 5, there is shown a NR SSB 500 that comprises a PSS 502, a SSS 504 and a Physical Broadcast Channel, PBCH 506. The PBCH 506 comprises a plurality of reference subcarriers 507. The plurality of reference subcarriers 507 may also be referred to as PBCH demodulation reference signals, DMRS. There is further shown a plurality of unused subcarriers 508 above and below the SSS 504. The NR SSB 500 is described in conjunction with a X-axis 510 and a Y-axis 512.

Each of the NR SSB 500, the PSS 502 and the SSS 504 corresponds to the partially pre-compensated SSB 204, the PSS 210 and the SSS 212, respectively, of FIG. 2. The X-axis 510 represents Orthogonal Frequency Division Multiplexing, OFDM symbols ranging from 0 to 4. The Y-axis 512 represents 20 Resource Blocks, RBs, across the PBCH 506. Each of the PSS 502 and the SSS 504 may also be referred to as Doppler shift pre-compensated PSS and SSS, respectively. For NTNs, the Doppler shifts vary among different satellite downlink beams therefore, a beam specific pre-compensation of the Doppler shift is used for the PSS 502 and the SSS 504 in order to speed up the cell detection. In pre-compensation of the Doppler shift, only the integer part of the Doppler shift is pre-compensated on the PSS 502 and the SSS 504. This corresponds to shifting the plurality of unused subcarriers 508 (i.e., PSS/SSS subcarriers) towards the null-subcarrier region within the NR SSB 500. Consequently, transmitted signals are still complaint with NR numerology. Moreover, a UE can detect the frequency sub-carrier shifted PSS and SSS (i.e., the PSS 502 and the SSS 504) with reduced computation complexity. After detecting the PSS 502 and the SSS 504, the UE can perform estimation of residual part of the Doppler shift and compute the PCI. Based on the detected PCI, the UE computes the positions of the PBCH DMRS symbols in the PBCH 506 block using the 3GPP TS38.211. However, since the PSS 502 and the SSS 504 are no longer centered in the NR SSB 500 due to the partial pre-compensation of the Doppler shift, the UE is required to perform hypothesis testing to find the relative position between the PBCH DMRS and the PSS 502 and the SSS 504 in the frequency domain. The various steps of the hypothesis testing are described in the following way:

The UE is required to estimate the residual Doppler shift from initial cell search procedure.

The UE is further required to compute the PCI based on the frequency pre-compensated PSS and SSS (i.e., the PSS 502 and the SSS 504) detection.

Based on the computed PCI, the UE is required to extract the DMRS from the PBCH 506.

The UE is further required to extract 2. Nₘₐₓ+1≤19 possible DMRS PBCH sequences due to unknown value of the absolute Doppler shift pre-compensation by N. SCS with −Nₘₐₓ≤N≤Nₘₐₓ, where |Nₘₐₓ|≤9 is a network specific parameter that is known to the UE. |Nₘₐₓ| is bounded by 9 subcarriers because a typical SSS in third OFDM symbol has a total of 18 subcarriers (9 above and 9 below the typical SSS). This corresponds to the maximum amount od Doppler shift that can be pre-compensated, which is required to be considered when the satellite constellation and the coverage area are designed.

The additional sequences are extracted by replacing v by \hat{v}=v+N

The UE is required to perform hypothesis testing on all possible (2·Nₘₐₓ+1) DMRS PBCH sequences using predefined metric M, Received Signal Received Power, RSRP, correlation peak value, etc.

The index of DMRS PBCH sequence with the highest metric indicates the estimated residual Doppler shift pre-compensated value \hat{N} according to equation (3).

$$\begin{matrix}a & \\ \hat{N} = arg {max}_{N ∈ \{ - {N}_{max} , ... , {N}_{max} \}} M ( N ) . & ( 3 )\end{matrix}$$

The total Doppler shift is computed according to equation (4).

$$\begin{matrix}a & \\ CFO = FFO + \hat{N} \cdot SCS . & ( 4 )\end{matrix}$$

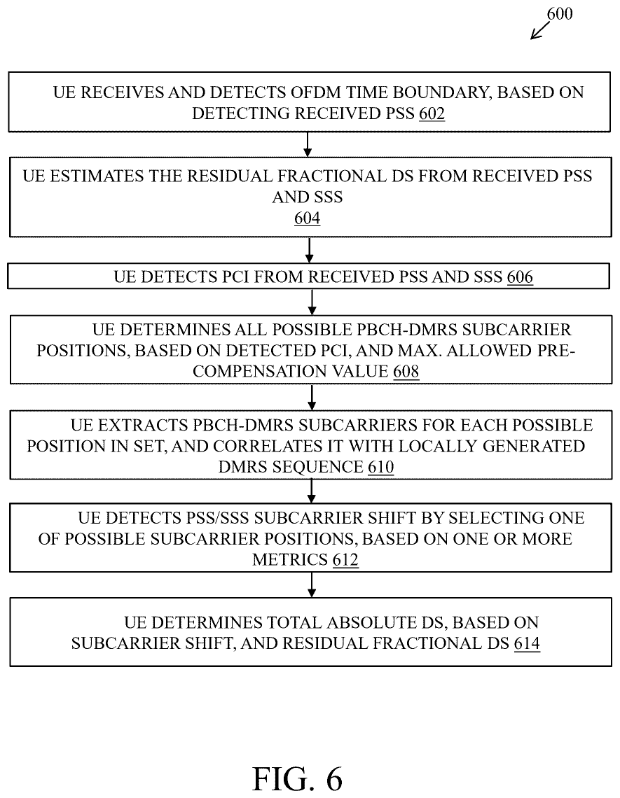

FIG. 6 is a method used by a User Equipment, UE, to detect the absolute Doppler shift using a partial Doppler shift pre-compensated SSB, in accordance with an embodiment of the present disclosure. FIG. 6 is described in conjunction with elements from FIGS. 1, 2, 3, 4, and 5. With reference to FIG. 6, there is shown a method 600 that includes steps 602 to 614. The method 600 is executed by the communication device 202 of FIG. 2. The method 600 is used by the UE (i.e., the communication device 202) to detect the absolute Doppler shift using the partial doppler shift pre-compensated SSB (i.e., the partially pre-compensated SSB 204).

At step 602, the UE is configured to receive and detect the OFDM timing boundary of a SSB based on detecting the received PSS. Since, the PSS (e.g., the PSS 210) and SSS (e.g., the SSS 212) within the SSB (i.e., the partially pre-compensated SSB 204) are compensated for the integer part of the Doppler shift, the UE can determine the timing boundary of the SSB simply by correlating the received SSB with locally generated PSS and SSS waveforms in a computationally efficient manner by constructing locally-generated and time-shifted versions of the PSS and SSS templates. Moreover, no hypothesis testing is required in the frequency domain.

At step 604, the UE is configured to determine the residual Doppler shift based on the received PSS and SSS. The UE can detect the timing boundary of the PSS and the residual Doppler shift using the correlation technique without much complexity.

At step 606, the UE is configured to detect PCI based on the received PSS and SSS. The UE detects the PCI by correlating the received PSS and SSS with 3-PSS and 336-SSS templates, respectively, which are locally generated, have been described in detail, for example, in FIG. 1.

At step 608, the UE is configured to determine a set of all possible PBCH DMRS subcarrier positions within the received SSB based on the detected PCI and the maximum allowed pre-compensation value (i.e., ±9).

At step 610, the UE is configured to extract the PBCH DMRS subcarriers for each possible position in the set determined in the step 608 from the received SSB and correlating the extracted PBCH DMRS subcarrier with a locally generated DMRS sequence. In the present disclosure, the UE is aware about that the PSS and SSS are partially Doppler shift compensated, which means that the PBCH DMRS positions extracted based on the detected PCI may vary from the original subcarrier locations. Therefore, the UE is configured to use the determined PCI to extract the PBCH DMRS original subcarriers, and additionally extracts integer shifts thereof equal to the amount of maximum possible shifts allowed by the available null-subcarriers (±9). This results in a total of 2*9+1=19 hypothetical PBCH DMRS positions. For each hypothetical PBCH DMRS position, UE extracts the PBCH DMRS and correlate it with a local DMRS sequence.

At step 612, the UE is configured to detect the PSS and SSS subcarrier shift by selecting one of the possible positions in the set determined in the step 608 based on one or a plurality of metric. Based on one or the plurality of metrics (e.g., correlation, RSRP, etc.), the UE decides which possible extracted PBCH DMRS subcarrier positions has the correct PBCH DMRS. The difference between the subcarrier positions from the received SSB and the subcarrier positions specified in a Table 7.4.3.1-1 in 3GPP TS38.211 corresponds to the integer Doppler shift that is pre-compensated on the satellite's (i.e., the NGSO satellite transmitter 208 of FIG. 2) side. This way, the UE can independently figure out the pre-compensated value with no explicit signaling from the satellite (i.e., the NGSO satellite transmitter 208 of FIG. 2) to the UE.

At step 614, the UE is configured to determine the total absolute Doppler shift based on the detected PSS and SSS subcarrier shift, which was detected in step 612, and the residual fractional Doppler shift detected in the step 604. The UE can determine the total Doppler shift similar to the equation (4) from the residual Doppler shift determined by the UE in the step 604, and the PBCH DMRS subcarriers shift determined by the UE in the step 612.

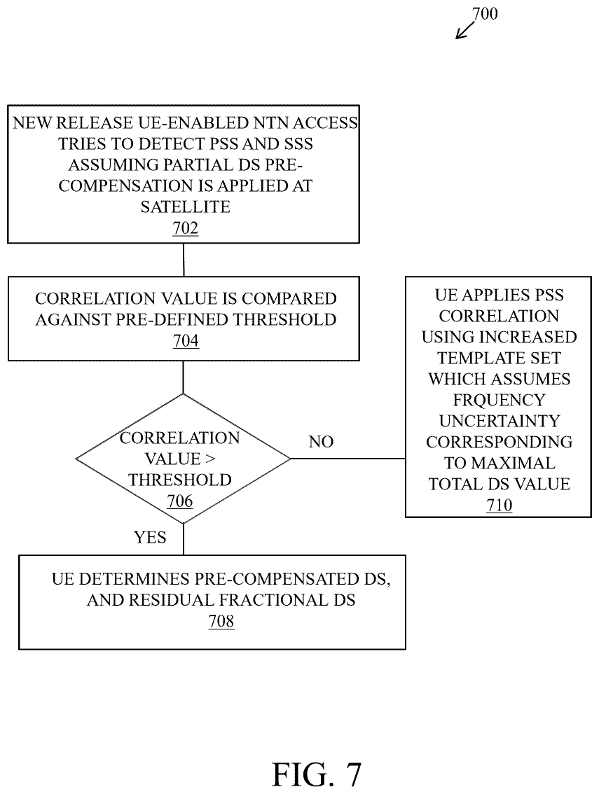

FIG. 7 is a flowchart used by a UE to determine whether a Base Station, BS, is applying a partial Doppler shift pre-compensation without explicit signaling, in accordance with an embodiment of the present disclosure. FIG. 7 is described in conjunction with elements from FIGS. 1, 2, 3, 4, 5, and 6. With reference to FIG. 7, there is shown a flowchart 700 that includes operations 702 to 710. The flowchart 700 is executed by the communication device 202 of FIG. 2. The flowchart 700 is used by the UE (i.e., the communication device 202) to determine whether a BS (i.e., the NGSO satellite transmitter 208 or a network component or a satellite) is applying a partial Doppler shift pre-compensation or not, by using the operations from 702 to 710.

At operation 702, the UE assumes that the BS (or the network component) is employing the partial Doppler shift pre-compensation. Thereafter, the UE proceeds to detect the PSS and the SSS to determine the SSB timing boundary using a small set (or a first set) of local PSS templates.

At operation 704, the UE correlates the received PSS and SSS subcarriers within the partially pre-compensated SSB with the small set of set (or the first set) of local PSS templates, by assuming a reduced frequency uncertainty corresponding to a maximal residual Doppler shift value after the partial pre-compensation.

At operation 706, the UE compares the correlation value (i.e., a PSS peak) with a pre-defined threshold value. If the correlation value is greater than the pre-defined threshold value then the operation 708 is executed. Otherwise, the operation 710 is executed.

At operation 708, the UE detects the correlation value above the pre-defined threshold value, the UE applies the method 600 (of FIG. 6) in order to determine the total Doppler shift.

At operation 710, the UE fails to detect the correlation value above the pre-defined threshold value, the UE assumes that the BS is not applying the partial Doppler shift pre-compensation. Therefore, the UE further applies the PSS correlation with a larger template set (or the second set) by assuming the frequency uncertainty corresponding to the maximal possible total Doppler shift value, in order to determine the total Doppler shift.

In another embodiment, the BS may be configured to indicate the UE whether the partial Doppler shift pre-compensation is applied on the PSS and the SSS or not. For the UE to be able to decode the PBCH using the partially pre-compensated Doppler shift PSS and SSS, the UE has to be informed that the BS (e.g., a LEO BS or the network component) applies the partial Doppler shift pre-compensation. Since messaging between the network and the UE in the initial cell search phase is not possible therefore, the UE can be informed by embedding the information in the PCI that is detected at the UE by finding PSS and SSS IDs. The partial Doppler shift pre-compensation is applied for PCIs that belong to a certain set of IDs (e.g., a first set), otherwise PCIs belong to a second set that does not apply partial Doppler shift pre-compensation. For example, even PCIs correspond to applying the partial Doppler shift pre-compensation, and odd PCIs correspond to not applying the partial Doppler shift pre-compensation. For example:

First set: PCI∈{0, 2, 4, 6, . . . , 1008}→if the detected PCI is in this set (i.e., even), then the BS applies the partial Doppler shift pre-compensation.

Second set: PCI∈{1, 3, 5, 7, . . . , 1007}→if the detected PCI is in this set (i.e., odd), then the BS does not apply the partial Doppler shift pre-compensation.

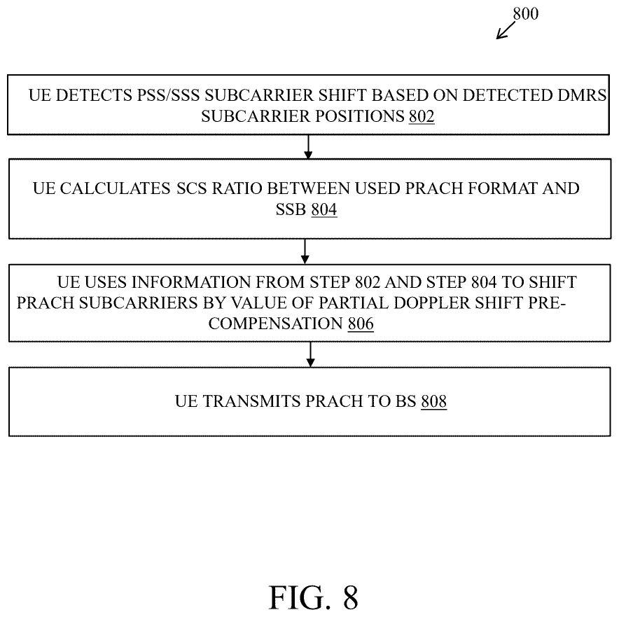

FIG. 8 is a method used by a UE to apply a partial Doppler shift pre-compensation on a Physical Random-Access Channel, PRACH, for the uplink, UL, transmission, in accordance with an embodiment of the present disclosure. FIG. 8 is described in conjunction with elements from FIGS. 1, 2, 3, 4, 5, 6 and 7. With reference to FIG. 8, there is shown a method 800 that includes steps 802 to 808. The method 800 is executed by the communication device 202 of FIG. 2. The method 800 is used by the UE (i.e., the communication device 202) to apply partial Doppler shift pre-compensation for the PRACH.

At step 802, the UE is configured to detect the PSS and the SSS integer subcarrier shift applied by the BS (i.e., the NGSO satellite transmitter 208) as described in FIGS. 1 and 6.

At step 804, the UE is configured to determine the SCS ratio between the used PRACH format and the SCS used for the received SSB.

At step 806, the UE is configured to use the information from the steps 802 and 804 to shift the PRACH subcarrier positions using the detected PSS and the SSS pre-compensated partial subcarrier shift and the SCS ratio between SSB and PRACH. This will ease the BS to detect the UE transmitted PRACH even with a large Doppler shift. Since, the detected PSS and SSS Doppler shift pre-compensated partial subcarrier is known to the BS, the PRACH subcarriers shift is also known to the BS. Hence BS can also determine the absolute DS value even though the PRACH signal is partially DS compensated.

At step 808, the UE is configured to transmit the partial pre-compensated PRACH to the BS onboard the satellite.

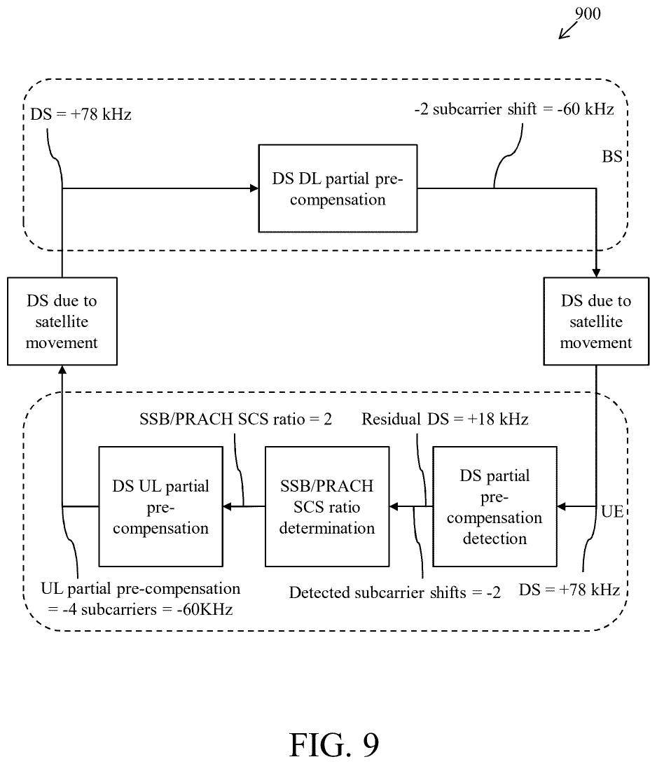

FIG. 9 illustrates an exemplary scenario of partial Doppler shift pre-compensation of PRACH, in accordance with an embodiment of the present disclosure. FIG. 9 is described in conjunction with elements from FIGS. 1, 2, 3, 4, 5, 6, 7, and 8. With reference to FIG. 9, there is shown an exemplary scenario 900 of partial Doppler shift pre-compensation of the PRACH.

In the exemplary scenario 900, it is assumed that the Doppler shift is +78 kHz, the SSB SCS is 30 kHz and the PRACH SCS is 15 kHz. Based on given parameters, the UE is required to detect the PSS and SSS Doppler shift pre-compensated subcarrier shift as −2. The UE is further configured to calculate the ratio between the SSB SCS and the PRACH SCS as 2. Thereafter, the UE is required to shift the PRACH subcarrier positions by −4 and transmit the partial pre-compensated PRACH to the BS.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A method (100), the method (100) comprising:
a communication device (202) receiving a partially pre-compensated synchronization signal block (SSB), (204) through a downlink (DL), beam (206) from a Non-Geostationary Orbit (NGSO) satellite transmitter (208) and achieving a cell synchronization with the NGSO satellite transmitter (208) using the partially pre-compensated SSB (204),
wherein a central frequency of a primary synchronization signal (PSS), (210) and a central frequency of a secondary synchronization signal (SSS), (212) within the partially pre-compensated SSB (204) are pre-shifted by the NGSO satellite transmitter (208) with respect to a central frequency of the partially pre-compensated SSB (204) by an integer number of subcarriers for a partial pre-compensation of a Doppler shift related to a movement of the NGSO satellite transmitter (208) with respect to a coverage area of the DL beam (206) on Earth.

2. The method (100) of claim 1, wherein the integer number of subcarriers to which the central frequencies of the PSS (210) and the SSS (212) are pre-shifted within the partially pre-compensated SSB (204) is determined based on an orbital height and a velocity of the NGSO satellite transmitter (208), the coverage area of the DL beam (206), a carrier frequency of a DL channel and a subcarrier spacing, SCS, of the partially pre-compensated SSB (204).

3. The method (100) of claim 1, wherein the central frequencies of the PSS (210) and the SSS (212) are pre-shifted in a range from −9 to +9 subcarriers within a null-subcarrier region of the partially pre-compensated SSB (204).

4. The method (100) of claim 1, comprising, for achieving the cell synchronization:
the communication device (202) correlating received DL signals containing the partially pre-compensated SSB (204) with a set of locally generated PSS waveforms each being shifted in frequency by a potential value of a residual part of the Doppler shift non-compensated by the partial pre-compensation by the NGSO satellite transmitter (208) and determining a maximum correlation value.

5. The method (100) of claim 4, further comprising, if the maximum correlation value is below a pre-defined threshold:
the communication device (202) achieving the cell synchronization by correlating the DL signals with a larger set of locally generated PSS waveforms each being shifted in frequency by a potential value of a maximum possible Doppler shift related to the NGSO satellite transmitter (208) movement with respect to the DL beam (206) coverage area.

6. The method (100) of claim 4, comprising, upon achieving the cell synchronization: the communication device (202) detecting a physical cell identity (PCI), and estimating the residual part of the Doppler shift based on the received PSS (210) and SSS (212).

7. The method (100) of claim 6, further comprising:
the communication device (202) determining a value of the partial pre-compensation of the Doppler shift by the NGSO satellite transmitter (208) based on a difference between the central frequencies of the subcarriers of the received PSS (210) and SSS (212) and a received demodulation reference signal (DMRS), for a physical broadcast channel (PBCH), (506) within the partially pre-compensated SSB (204).

8. The method (100) of claim 7, further comprising:
the communication device (202) determining a value of the Doppler shift related to the NGSO satellite transmitter (208) movement with respect to the coverage area of the DL beam (206) based on the estimated residual part of the Doppler shift and the determined value of the partial pre-compensation of the Doppler shift.

9. The method (100) of claim 8, further comprising:
the communication device (202) using the determined value of the Doppler shift to compensate a phase distortion of a DL data signal associated with the DL beam (206), wherein the DL data signal comprises a Physical Downlink Control Channel (PDCCH), signal or a Physical Downlink Shared Channel (PDSCH), signal.

10. A communication device (202), the communication device (202) being configured for:
receiving a partially pre-compensated synchronization signal block (SSB), (204) through a downlink (DL), beam (206) from a Non-Geostationary Orbit (NGSO) satellite transmitter (208), and
achieving a cell synchronization with the NGSO satellite transmitter (208) using the partially pre-compensated SSB (204),
wherein a central frequency of a primary synchronization signal (PSS), (210) and a central frequency of a secondary synchronization signal (SSS), (212) within the partially pre-compensated SSB (204) are pre-shifted by the NGSO satellite transmitter (208) with respect to a central frequency of the partially pre-compensated SSB (204) by an integer number of subcarriers for a partial pre-compensation of a Doppler shift related to a movement of the NGSO satellite transmitter (208) with respect to a coverage area of the DL beam (206) on Earth.

11. The communication device (202) of claim 10, wherein the integer number of subcarriers to which the central frequencies of the PSS (210) and the SSS (212) are pre-shifted within the partially pre-compensated SSB (204) is determined based on an orbital height and a velocity of the NGSO satellite transmitter (208), the coverage area of the DL beam (206), a carrier frequency of a DL channel and a subcarrier spacing (SCS), of the partially pre-compensated SSB (204).

12. The communication device (202) of claim 10, wherein the central frequencies of the PSS (210) and the SSS (212) are pre-shifted in a range from −9 to +9 subcarriers within a null-subcarrier region of the partially pre-compensated SSB (204).

13. The communication device (202) of claim 10, being configured for achieving the cell synchronization by means of:
correlating received DL signals containing the partially pre-compensated SSB (204) with a set of locally generated PSS waveforms each being shifted in frequency by a potential value of a residual part of the Doppler shift non-compensated by the partial pre-compensation by the NGSO satellite transmitter (208), and
determining a maximum correlation value.

14. The communication device (202) of claim 13, being further configured, if the maximum correlation value is below a pre-defined threshold, for:
achieving the time cell synchronization by correlating the DL signals with a larger set of locally generated PSS waveforms each being shifted in frequency by a potential value of a maximum possible Doppler shift related to the NGSO satellite transmitter (208) movement with respect to the DL beam (206) coverage area.

15. The communication device (202) of claim 13, being configured, upon achieving the cell synchronization, for:
detecting a physical cell identity (PCI), and estimating the residual part of the Doppler shift based on the received PSS (210) and SSS (212).

16. The communication device (202) of claim 15, being further configured for:
determining a value of the partial pre-compensation of the Doppler shift by the NGSO satellite transmitter (208) based on a difference between the central frequencies of the subcarriers of the received PSS and SSS and a received demodulation reference signal (DMRS), for a physical broadcast channel (PBCH), (506) within the partially pre-compensated SSB (204).

17. The communication device (202) of claim 16, being further configured for:
determining a value of the Doppler shift related to the NGSO satellite transmitter (208) movement with respect to the coverage area of the DL beam (206) based on the estimated residual part of the Doppler shift and the determined value of the partial pre-compensation of the Doppler shift.

18. The communication device (202) of claim 17, being further configured for:
using the determined value of the Doppler shift to compensate a phase distortion of a DL data signal associated with the DL beam (206), wherein the DL data signal comprises a Physical Downlink Control Channel (PDCCH), signal or a Physical Downlink Shared Channel (PDSCH), signal.

19. A satellite transmitter (208) being configured for:
determining a value of a partial pre-compensation of a Doppler shift related to a movement of the satellite transmitter (208) with respect to a coverage area of a downlink (DL), beam (206) on Earth,
pre-shifting a central frequency of a primary synchronization signal (PSS), (210) and a central frequency of a secondary synchronization signal (SSS), (212) within a synchronization signal block (SSB), with respect to a central frequency of the SSB by an integer number of subcarriers that corresponds to the determined value of the partial pre-compensation of the Doppler shift to obtain a partially pre-compensated SSB, (204) and transmitting the partially pre-compensated SSB (204) within the coverage area of the DL beam (206).

20. The satellite transmitter (208) of claim 19, wherein the integer number of subcarriers to which the central frequencies of the PSS (210) and the SSS (212) are pre-shifted within the partially pre-compensated SSB (204) is determined based on an orbital height and a velocity of the satellite transmitter (208), the coverage area of the DL beam (206), a carrier frequency of a DL channel and a subcarrier spacing (SCS), of the partially pre-compensated SSB (204).
